(19) United States
(12) Patent Application Publication
(10) Pub. No.: US 2022/0200115 A1
(43) Pub. Date: Jun. 23, 2022

(54) WAVEGUIDE WITH SLOT-FED DIPOLE ELEMENTS

(71) Applicant: Aptiv Technologies Limited, St. Michael (BB)

(72) Inventors: Mingjian Li, Santa Clara, CA (US); Shawn Shi, Thousand Oaks, CA (US)

(21) Appl. No.: 17/234,238

(22) Filed: Apr. 19, 2021

Related U.S. Application Data
(60) Provisional application No. 63/169,062, filed on Mar. 31, 2021.
(60) Provisional application No. 63/127,819, filed on Dec. 18, 2020.
(60) Provisional application No. 63/127,861, filed on Dec. 18, 2020.
(60) Provisional application No. 63/127,873, filed on Dec. 18, 2020.

(51) Int. Cl. H01P 3/02; H01P 3/16; H01Q 13/02

(52) U.S. Cl. CPC H01P 3/023; H01Q 13/0233; H01P 3/16

(57) ABSTRACT

This document describes a waveguide with slot-fed dipole elements. An apparatus may include a waveguide for providing narrow coverage in an azimuth plane. The waveguide includes a hollow channel containing a dielectric and an array of radiation slots through a surface that is operably connected with the dielectric. The waveguide includes an array of dipole elements positioned on or in the surface and offset from each longitudinal side of the array of radiation slots. The radiation slots and the dipole elements configure the described waveguide to focus an antenna radiation pattern that supports a narrow beamwidth.

### CROSS-REFERENCE TO RELATED APPLICATIONS

This application claims the benefit under 35 U.S.C. 119(e) of U.S. Provisional Application No. 63/169,062, filed Mar. 31, 2021, and U.S. Provisional Application Nos. 63/127,819, 63/127,861, and 63/127,873, each filed Dec. 18, 2020, the disclosures of which are hereby incorporated by reference in their entirety herein.

### BACKGROUND

Some devices (e.g., radar systems) use electromagnetic signals to detect and track objects. The electromagnetic signals are transmitted and received using one or more antennas. The radiation pattern of an antenna may be characterized by gain or beamwidth, which indicates gain as a function of direction. Precisely controlling the radiation pattern can improve the application of a radar system. For example, many automotive applications require radar systems that provide a narrow beamwidth to detect objects within a particular field-of-view (e.g., in a travel path of the vehicle). A waveguide may be used to improve and control the radiation pattern of such devices. Such waveguide can include perforations or radiating slots to guide radiation near the antenna. These waveguides, however, can generate a wider beamwidth than that which is required or desired for many applications.

### SUMMARY

This document describes techniques, apparatuses, and systems for a waveguide with slot-fed dipole elements. An apparatus may include a waveguide for providing narrow coverage in an azimth plane. The waveguide includes a hollow channel containing a dielectric and an array of radiation slots through a surface that is operably connected with the dielectric. The waveguide includes an array of dipole elements positioned on or in the surface and offset from each longitudinal side of the array of radiation slots. The radiation slots and dipole elements configure the described waveguide to focus an antenna radiation pattern that supports a narrow beamwidth.

This document also describes methods performed by the above-summarized techniques, apparatuses, and systems, and other methods set forth herein, as well as means for performing these methods.

This Summary introduces simplified concepts related to a waveguide with slot-fed dipole elements, further described in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of a waveguide with slot-fed dipole elements are described in this document with reference to the following figures. The same numbers are often used throughout the drawings to reference like features and components:

FIG. 1 illustrates an example environment in which a radar system with a waveguide with slot-fed dipole elements is used on a vehicle;

FIG. 2 illustrates a top view of a waveguide with slot-fed dipole elements;

FIG. 3 illustrates a cross-section view of a waveguide with slot-fed dipole elements;

FIGS. 4A and 4B illustrate radiation patterns associated with example waveguides without and with slot-fed dipole elements, respectively;

FIGS. 5A and 5B illustrate views of another waveguide with slot-fed dipole elements;

FIGS. 6A and 6B illustrate views of a waveguide with slot-fed dipole elements and a zigzag waveguide channel;

FIGS. 7A and 7B illustrate views of a waveguide with another example of slot-fed dipole elements; and

FIG. 8 illustrates an example method for manufacturing a waveguide with slot-fed dipole elements following techniques, apparatuses, and systems of this disclosure.

### DETAILED DESCRIPTION

Overview

Radar systems are a sensing technology that some automotive systems rely on to acquire information about the surrounding environment. Radar systems generally use an antenna to direct electromagnetic energy or signals being transmitted or received. Such radar systems can use multiple antenna elements in an array to provide increased gain and directivity in comparison to the radiation pattern achievable with a single antenna element. Signals from the multiple antenna elements are combined with appropriate phases and weighted amplitudes to provide the desired radiation pattern.

Consider a waveguide used to transfer electromagnetic energy to and from the antenna elements. The waveguide generally includes an array of radiation slots representing apertures in the waveguide. Manufacturers may select the number and arrangement of the radiation slots to provide the desired phasing, combining, or splitting of electromagnetic energy. For example, the radiation slots are equally spaced in a waveguide surface along a propagation direction of the electromagnetic energy. This arrangement of radiating slots generally provides a wide radiation pattern with relatively uniform radiation in the azimuth plane.

This document describes a waveguide with slot-fed dipole elements that provides a narrow beamwidth in the azimuth plane. The waveguide includes dipole elements on two sides of each radiation slot for a narrower radiation pattern. The dipole elements are positioned on an outer surface of the waveguide. In some implementations, the dipole elements have an approximately rectangular shape. The dipole elements have an approximately circular shape, oval shape, C shape, T shape, or L shape in other implementations. The dipole elements can be sized and positioned relative to the array of radiation slots to generate a radiation pattern with a narrow beamwidth and higher gain within the desired field-of-view.

The described waveguide may be particularly advantageous for use in an automotive context, for example, detecting objects in a roadway in a travel path of a vehicle. The narrow beamwidth allows a radar system of the vehicle to detect objects in a particular field-of-view (e.g., immediately in front of the vehicle). As one example, a radar system placed near the front of a vehicle can use a narrow beamwidth to focus on detecting objects immediately in front of the vehicle instead of objects located toward a side of the vehicle.

This example waveguide is just one example of the described techniques, apparatuses, and systems of a waveguide with slot-fed dipole elements. This document describes other examples and implementations.

Operating Environment

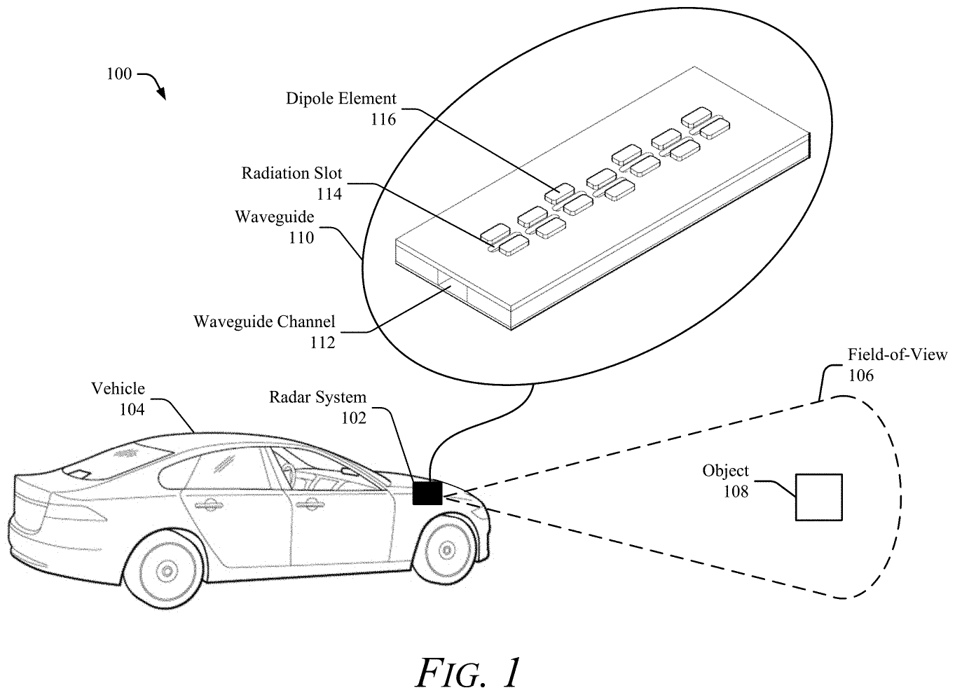

FIG. 1 illustrates an example environment 100 in which a radar system 102 with a waveguide 110 with slot-fed dipole elements 116 is used on a vehicle 104. The vehicle 104 may use the waveguide 110 to enable operations of the radar system 102 that is configured to determine a proximity, an angle, or a velocity of one or more objects 108 in the proximity of the vehicle 104.

Although illustrated as a car, the vehicle 104 can represent other types of motorized vehicles (e.g., a motorcycle, a bus, a tractor, a semi-trailer truck, or construction equipment), non-motorized vehicles (e.g., a bicycle), railed vehicles (e.g., a train or a trolley car), watercraft (e.g., a boat or a ship), aircraft (e.g., an airplane or a helicopter), or spacecraft (e.g., satellite). In general, manufacturers can mount the radar system 102 to any moving platform, including moving machinery or robotic equipment. In other implementations, other devices (e.g., desktop computers, tablets, laptops, televisions, computing watches, smartphones, gaming systems, and so forth) may incorporate the radar system 102 with the waveguide 110 and support techniques described herein.

In the depicted environment 100, the radar system 102 is mounted near, or integrated within, a front portion of the vehicle 104 to detect the object 108 and avoid collisions. The radar system 102 provides a field-of-view 106 towards the one or more objects 108. The radar system 102 can project the field-of-view 106 from any exterior surface of the vehicle 104. For example, vehicle manufacturers can integrate the radar system 102 into a bumper, side mirror, headlights, rear lights, or any other interior or exterior location where the object 108 requires detection. In some cases, the vehicle 104 includes multiple radar systems 102, such as a first radar system 102 and a second radar system 102 that provide a larger field-of-view 106. In general, vehicle manufacturers can design the locations of the one or more radar systems 102 to provide a particular field-of-view 106 that encompasses a region of interest, including, for instance, in or around a travel lane aligned with a vehicle path.

Example fields-of-view 106 include a 360-degree field-of-view, one or more 180-degree fields-of-view, one or more 90-degree fields-of-view, and so forth, which can overlap or be combined into a field-of-view 106 of a particular size. As described above, the described waveguide 110 includes dipole elements 116 to provide a radiation pattern with a narrower coverage in the azimuth plane and/or the elevation plane. As one example, a radar system placed near the front of a vehicle can use a narrow beamwidth to focus on detecting objects immediately in front of the vehicle (e.g., in a travel lane aligned with a vehicle path) instead of objects located toward a side of the vehicle (e.g., ahead of the vehicle 104 and in an adjacent travel lane to the vehicle path). For example, the narrow coverage or narrow beamwidth can concentrate the radiated EM energy within plus or minus approximately 20 to 45 degrees of a direction following a travel path of the vehicle 104. In contrast, a waveguide without the described configuration of dipole elements may provide a relatively uniform radiation pattern with the radiated EM energy within plus or minus approximately 75 degrees of the travel-path direction.

The object 108 is composed of one or more materials that reflect radar signals. Depending on the application, the object 108 can represent a target of interest. In some cases, the object 108 can be a moving object or a stationary object. The stationary objects can be continuous (e.g., a concrete barrier, a guard rail) or discontinuous (e.g., a traffic cone) along a road portion.

The radar system 102 emits electromagnetic radiation by transmitting one or more electromagnetic signals or waveforms via dipole elements 116. In the environment 100, the radar system 102 can detect and track the object 108 by transmitting and receiving one or more radar signals. For example, the radar system 102 can transmit electromagnetic signals between 100 and 400 gigahertz (GHz), between 4 and 100 GHz, or between approximately 70 and 80 GHz.

The radar system 102 can determine a distance to the object 108 based on the time it takes for the signals to travel from the radar system 102 to the object 108 and from the object 108 back to the radar system 102. The radar system 102 can also determine the location of the object 108 in terms of an angle based on the direction of a maximum amplitude echo signal received by the radar system 102.

The radar system 102 can be part of the vehicle 104. The vehicle 104 can also include at least one automotive system that relies on data from the radar system 102, including a driver-assistance system, an autonomous-driving system, or a semi-autonomous-driving system. The radar system 102 can include an interface to the automotive systems. The radar system 102 can output, via the interface, a signal based on electromagnetic energy received by the radar system 102.

Generally, the automotive systems use radar data provided by the radar system 102 to perform a function. For example, the driver-assistance system can provide blind-spot monitoring and generate an alert indicating a potential collision with the object 108 detected by the radar system 102. In this case, the radar data from the radar system 102 indicates when it is safe or unsafe to change lanes. The autonomous-driving system may move the vehicle 104 to a particular location on the road while avoiding collisions with the object 108 detected by the radar system 102. The radar data provided by the radar system 102 can provide information about a distance to and the location of the object 108 to enable the autonomous-driving system to perform emergency braking, perform a lane change, or adjust the speed of the vehicle 104.

The radar system 102 generally includes a transmitter (not illustrated) and at least one antenna, including the waveguide 110, to transmit electromagnetic signals. The radar system 102 generally includes a receiver (not illustrated) and at least one antenna, including the waveguide 110, to receive reflected versions of these electromagnetic signals. The transmitter includes components for emitting electromagnetic signals. The receiver includes components to detect the reflected electromagnetic signals. The transmitter and the receiver can be incorporated together on the same integrated circuit (e.g., a transceiver integrated circuit) or separately on different integrated circuits.

The radar system 102 also includes one or more processors (not illustrated) and computer-readable storage media (CRM) (not illustrated). The processor can be a microprocessor or a system-on-chip. The processor executes instructions stored within the CRM. As an example, the processor can control the operation of the transmitter. The processor can also process electromagnetic energy received by the antenna and determine the location of the object 108 relative to the radar system 102. The processor can also generate radar data for the automotive systems. For example, the processor can control, based on processed electromagnetic energy from the antenna, an autonomous or semi-autonomous driving system of the vehicle 104.

The waveguide 110 includes at least one layer that can be any solid material, including wood, carbon fiber, fiber glass, metal, plastic, or a combination thereof. The waveguide 110 can also include a printed circuit board (PCB). The waveguide 110 is designed to mechanically support and electrically connect components (e.g., a waveguide channel 112, radiation slots 114, dipole elements 116) to a dielectric using conductive materials. The waveguide channel 112 includes a hollow channel to contain the dielectric (e.g., air). The radiation slots 114 provide an opening through a layer or surface of the waveguide 110. The radiation slots 114 are configured to allow electromagnetic energy to dissipate to the environment 100 from the dielectric in the waveguide channel 112. The dipole elements 116 are formed on the surface of the waveguide 110 and to the side of the radiation slots 114. The dipole elements 116 act as radiating elements for the electromagnetic energy dissipating through the radiation slots 114 and effectively concentrate the radiation pattern to a narrower field-of-view 106.

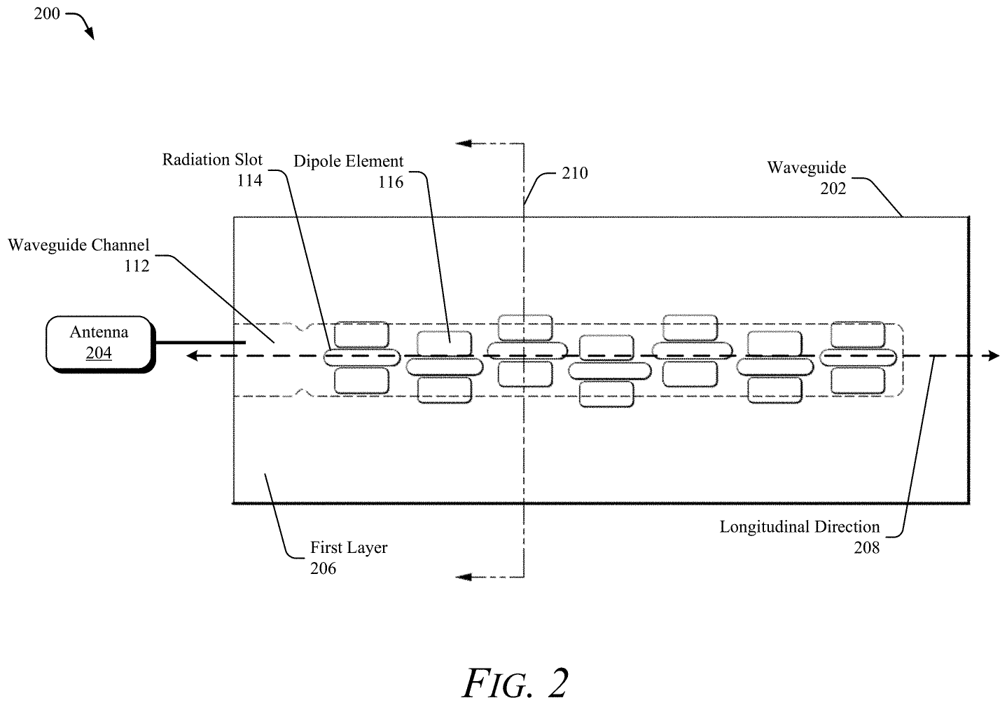

This document describes example embodiments of the waveguide 110 to provide narrow coverage in an antenna radiation pattern in greater detail with respect to FIGS. 2 through 7B. The narrow beamwidth allows a radar system 102 of the vehicle 104 to detect objects 108 in a particular field-of-view 106 (e.g., immediately in front of the vehicle). As described above, a radar system 102 placed near the front of a vehicle 104 can use a narrow beamwidth in one plane (e.g., the azimuth plane) to focus on detecting objects 108 immediately in front of the vehicle 104 instead of objects located toward a side of the vehicle 104.

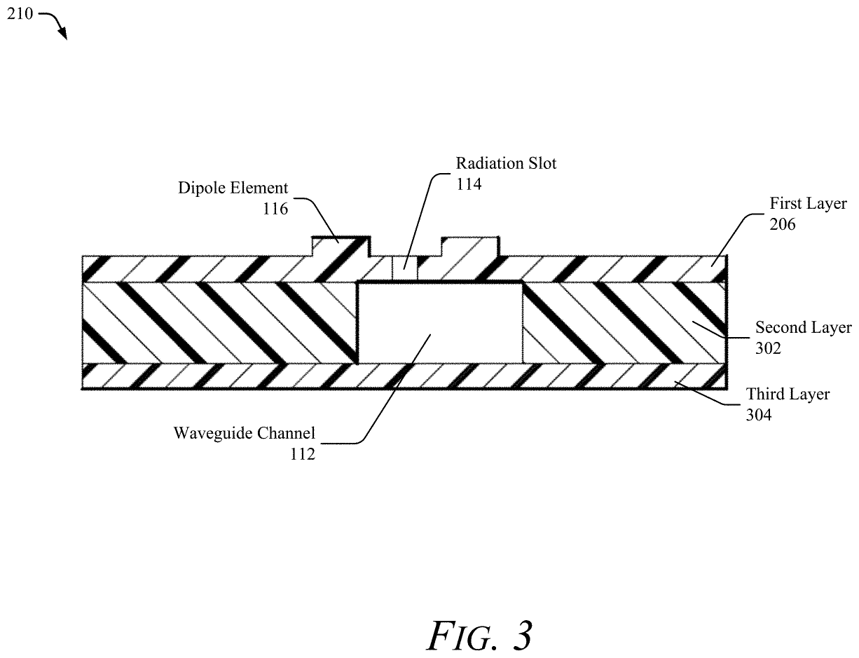

FIG. 2 illustrates a top view 200 of a waveguide 202 with slot-fed dipole elements 116. The waveguide 202 is an example of the waveguide 110 of FIG. 1. A cross-section view 210 of the waveguide 202 is illustrated in FIG. 3. The waveguide 202 includes the waveguide channel 112, multiple radiation slots 114, and multiple dipole elements 116.

The waveguide channel 112 is configured to channel electromagnetic signals transmitted by the transmitter and an antenna 204. The antenna 204 can be electrically coupled to a floor of the waveguide channel 112. The floor of the waveguide channel 112 is opposite a first layer 206, on which the dipole elements 116 are positioned.

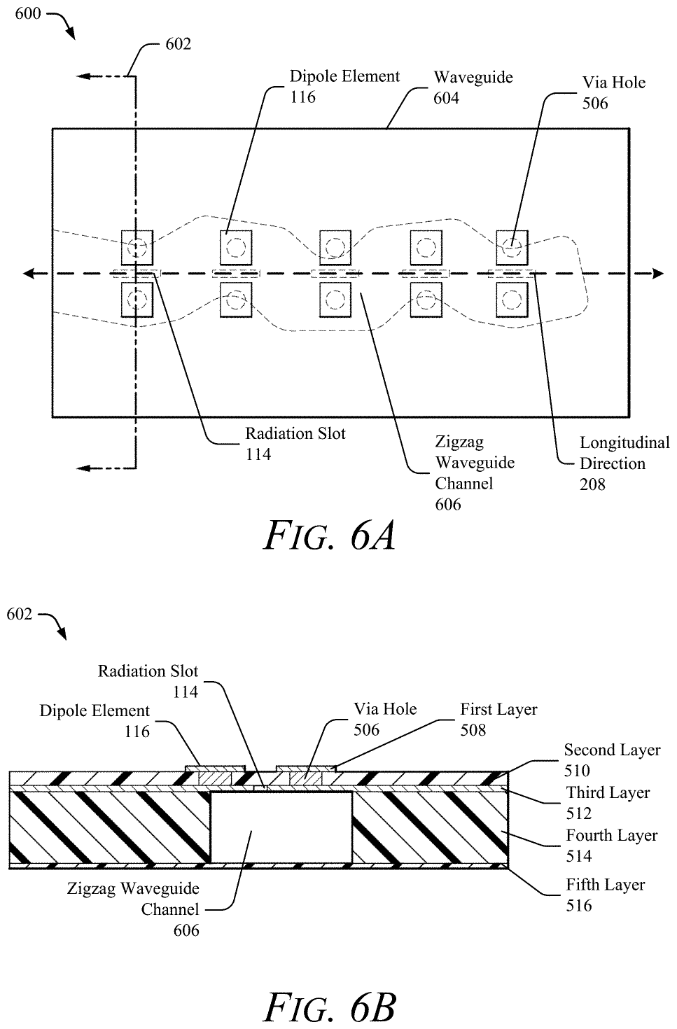

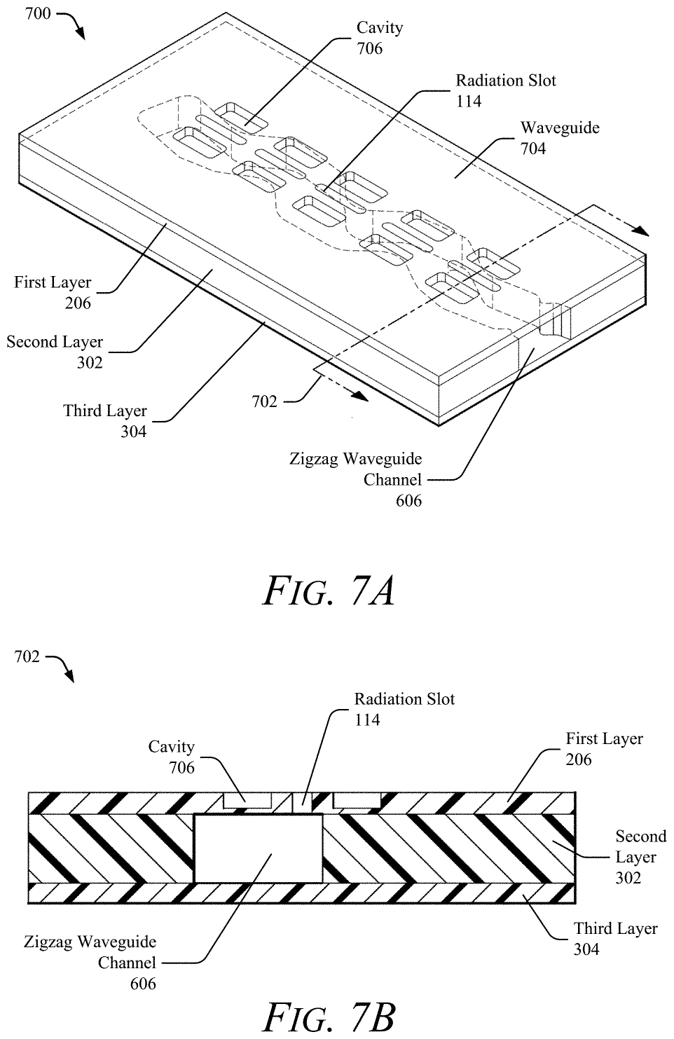

The waveguide channel 112 can include a hollow channel for a dielectric. The dielectric generally includes air, and the waveguide 202 is an air waveguide. The waveguide channel 112 forms an opening in a longitudinal direction 208 at one end of the waveguide 202 and a closed wall at an opposite end. The antenna 204 is electrically coupled to the dielectric via the floor of the waveguide channel 112. Electromagnetic signals enter the waveguide channel 112 through the opening and exit the waveguide channel 112 via the radiation slots 114. In FIG. 2, the waveguide channel 112 forms an approximately rectangular shape in the longitudinal direction 208. As discussed with respect to FIGS. 6A, 6B, 7A, and 7B, the waveguide channel 112 can also form a zigzag shape in the longitudinal direction 208.

The radiation slots 114 provide an opening through the first layer 206 that defines a surface of the waveguide channel 112. For example, the radiation slots 114 can have an approximately rectangular shape (e.g., a longitudinal slot parallel to the longitudinal direction 208) as illustrated in FIG. 2. The longitudinal slots allow the radiation slots 114, in combination with the dipole elements 116, to produce a horizontal-polarized radiation pattern. The radiation slots 114 can have other shapes in other implementations, including approximately circular, oval, or square.

The radiation slots 114 are sized and positioned on the first layer 206 to produce a particular radiation pattern for the antenna 204. For example, at least some of the radiation slots 114 are offset from the longitudinal direction 208 (e.g., a centerline of the waveguide channel 112) by varying or non-uniform distances (e.g., in a zigzag shape) to reduce or eliminate side lobes from the radiation pattern of the waveguide 202. As another example, the radiation slots 114 nearer the wall at the opposite end of the waveguide channel 112 can have a larger longitudinal opening than the radiation slots 114 nearer the opening of the waveguide channel 112. The specific size and position of the radiation slots 114 can be determined by building and optimizing a model of the waveguide 202 to produce the desired radiation pattern.

As illustrated in FIG. 2, the plurality of radiation slots 114 is evenly distributed along the waveguide channel 112 between the opening of the waveguide channel and the closed wall. Each adjacent pair of radiation slots 114 are separated along the longitudinal direction 208 by a uniform distance to produce a particular radiation pattern. The uniform distance, which is generally less than one wavelength of the electromagnetic radiation, can prevent grating lobes in the radiation pattern.

The dipole elements 116 are formed on an outer surface of the first layer 206. The dipole elements 116 have an approximately rectangular shape in the depicted implementation. The dipole elements 116 can have an approximately circular shape, oval shape, C shape, T shape, or L shape in other implementations. In yet other implementations, the dipole elements 116 can combine the described shapes. A dipole element 116 is positioned adjacent to and offset from a longitudinal side of each radiation slot 114. The longitudinal sides of the radiation slots 114 are approximately parallel to the longitudinal direction 208. The dipole elements 116 can be offset a first distance from the longitudinal sides of the radiation slots 114 to generate a particular band of coverage in the radiation pattern of the antenna 204. The dipole elements 116 can also have a height that is less than the depth of the radiation slots 114.

The electromagnetic radiation that leaks through the radiation slots 114 may excite the dipole elements 116 to generate a radiation pattern with a narrow beamwidth in the azimuth plane. The shape and size of the dipole elements 116 can be configured to vary the bandwidth and characteristics of the radiation pattern. The specific size and position of the dipole elements 116 can be determined by building and optimizing a model of the waveguide 202 to produce the desired radiation pattern.

FIG. 3 illustrates the cross-section view 210 of the waveguide 202 with slot-fed dipole elements. The waveguide 202 includes the first layer 206, a second layer 302, and a third layer 304. The first layer 206, the second layer 302, and the third layer 304 can be metal or metal-plated material. The radiation slots 114 form openings in the first layer 206 into the waveguide channel 112. The dipole elements 116 are formed on or as part of the first layer 206. The second layer 302 forms sides of the waveguide channel 112. The third layer 304 forms the floor of the waveguide channel 112. In the depicted implementation, the first layer 206, the second layer 302, and the third layer 304 are separate layers. In other implementations, the first layer 206, the second layer 302, and the third layer 304 can be formed as a single layer that defines the waveguide channel 112, the radiation slots 114, and the dipole elements 116.

As depicted in FIG. 3, the waveguide channel 112 can form an approximately rectangular opening in the cross-section view 210 of the waveguide 202. In other implementations, the waveguide channel 112 can form an approximately square, oval, or circular opening in the cross-section view 210 of the waveguide 202.

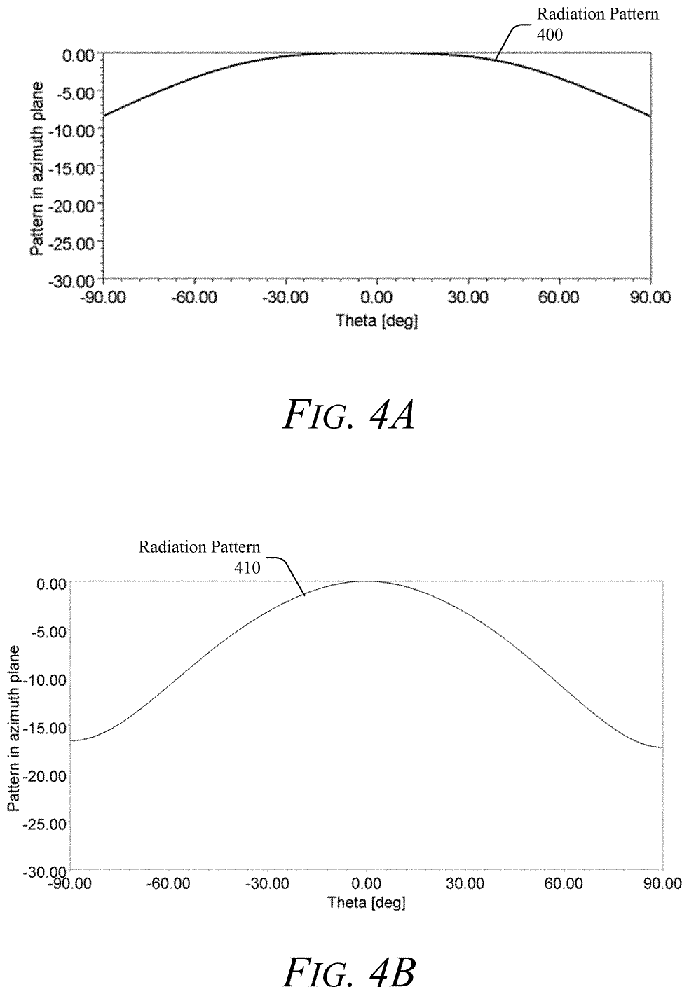

FIG. 4A illustrates a radiation pattern 400 associated with an example waveguide without slot-fed dipole elements. The example waveguide without slot-fed dipole elements can generate a uniform radiation pattern 400 in an azimuth plane but with a relatively wide beamwidth.

In contrast to FIG. 4A, FIG. 4B illustrates a radiation pattern 410 associated with an example waveguide with slot-fed dipole elements. This generates a uniform radiation pattern 410, also in the azimuth plane, but with a relatively narrow beamwidth. The example waveguide can include the waveguide 202 illustrated in FIGS. 2 and 3 with the radiation slots 114 and the dipole elements 116. The waveguide 202 can generate the uniform radiation pattern 410 with the narrow beamwidth in the azimuth plane to enable a radar system to focus the radiation pattern of a corresponding antenna on a narrower field-of-view where potential objects-of-interest are located than the radar system can using the radiation pattern 400 illustrated in FIG. 4A. As one example, a radar system placed near the front of a vehicle can use a narrow beamwidth to focus on detecting objects immediately in front of the vehicle instead of objects located toward a side of the vehicle.

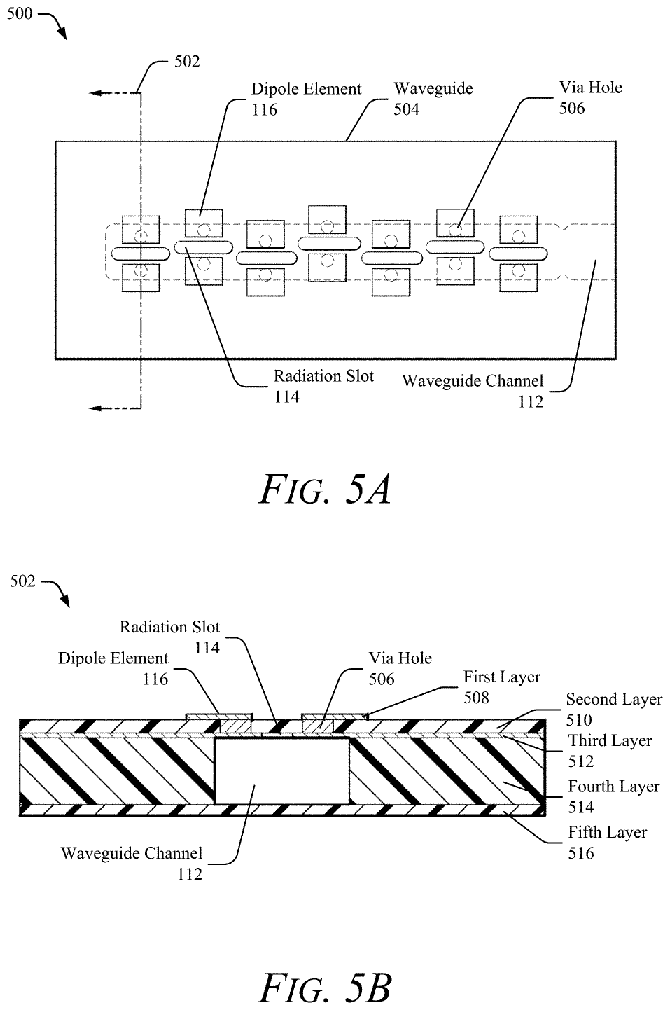

FIG. 5A illustrates a top view 500 of a waveguide 504 with slot-fed dipole elements 116. FIG. 5B illustrates a cross-section view 502 of the waveguide 504. The waveguide 504 includes the waveguide channel 112, the radiation slots 114, and the dipole elements 116.

The waveguide 504 includes a first layer 508, a second layer 510, a third layer 512, a fourth layer 514, and a fifth layer 516. The first layer 508, the second layer 510, and the third layer d512 provide a top conductive layer, a substrate layer, and a bottom conductive layer, respectively, of a printed circuit board (PCB). The first layer 508 and the third layer 512 can include various conductive materials, including tin-lead, silver, gold, copper, and so forth, to enable the transport of electromagnetic energy. Like the second layer 302 and the third layer 304 illustrated in FIG. 3, the fourth layer 514 and the fifth layer 516 form sides and the floor, respectively, of the waveguide channel 112. The fourth layer 514 and the fifth layer 516 are separate layers in the depicted implementation. In other implementations, the fourth layer 514 and the fifth layer 516 can be formed as a single layer and combined with the PCB structure to form the waveguide channel 112.

The use of the PCB structure for the waveguide 504 provides several advantages over the structure of the waveguide 202 illustrated in FIGS. 2 and 3. For example, using a PCB allows manufacturing of the waveguide 504 to be cheaper, less complicated, and easier for mass production. As another example, the PCB use provides low loss of electromagnetic radiation from the input of the waveguide channel 112 to radiation from the dipole elements 116.

The first layer 508 can be etched to form the dipole elements 116 as part of the top conductive layer of the PCB. The third layer 512 can be etched to form the radiation slots 114 as part of the bottom conductive layer of the PCB. Via holes 506 provide a hole in the second layer 510 to electrically and mechanically connect the dipole elements 116 to the third layer 512. The via holes 506 illustrated in the top view 500 and the cross-section view 502 resemble a cylinder with a circular cross-section. The via holes 506 may include various shapes, including an approximately rectangular, oval, or square cross-section. The via holes 506 may also include various sizes (e.g., diameters). The via holes 506 are plated or filled with a conductive material, generally the same conductive material used for the first layer 508 and the third layer 512.

FIG. 6A illustrates a top view 600 of a waveguide 604 with slot-fed dipole elements 116 and a zigzag waveguide channel 606. FIG. 6B illustrates a cross-section view 602 of the waveguide 604. The waveguide 604 includes the radiation slots 114, the dipole elements 116, and the via holes 506, similar to those illustrated for the waveguide 504 of FIGS. 5A and 5B. The waveguide 604 also includes the first layer 508, the second layer 510, the third layer 512, the fourth layer 514, and the fifth layer 516, similar to those illustrated for the waveguide 504 in FIGS. 5A and 5B. Like the waveguide 504, the first layer 508, the second layer 510, and the third layer 512 of the waveguide 604 provide a top conductive layer, a substrate layer, and a bottom conductive layer, respectively, of a printed circuit board (PCB).

As illustrated in FIG. 6A, the zigzag waveguide channel 606 forms a zigzag shape in the longitudinal direction 208. The zigzag shape of the zigzag waveguide channel 606 can reduce or eliminate grating lobes in the radiation pattern that a straight or rectangular waveguide shape can introduce (e.g., the waveguide channel 112). The turns in the zigzag shape can include various turning angles to provide the zigzag shape in the longitudinal direction 208. The turning angle of the zigzag waveguide is larger than 0 degree but less than 90 degrees.

As depicted in FIG. 6B, the zigzag waveguide channel 606 forms an approximately rectangular opening in the cross-section view 602 of the waveguide 604. In other implementations, the zigzag waveguide channel 606 can form an approximately square, oval, or circular opening in the cross-section view 602.

The plurality of radiation slots 114 is evenly distributed along the zigzag waveguide channel 606 between the opening of the waveguide channel and the closed wall. Each adjacent pair of radiation slots 114 are separated along the longitudinal direction 208 by a uniform distance to produce a particular radiation pattern. The zigzag shape of the zigzag waveguide channel 606 allows manufacturers to position the radiation slots 114 in an approximately straight line along the longitudinal direction 208.

As depicted in FIG. 6A, the dipole elements 116 include an array of dipole elements 116 positioned on both longitudinal sides of the radiation slots 114. In other implementations, the dipole element 116 can include a single dipole element 116 positioned on both longitudinal sides of the radiation slots 114. In other words, the dipole elements 116 can include two approximately rectangular elements that extend lengthwise in the longitudinal direction from the radiation slot 114 nearest to the opening of the zigzag waveguide channel 606 to the radiation slot 114 nearest the closed end of the zigzag waveguide channel 606.

FIG. 7A illustrates a perspective view 700 of a waveguide 704 with another example of slot-fed cavities 706 and the zigzag waveguide channel 606. FIG. 7B illustrates a cross-section view 702 of the waveguide 704.

The waveguide 704 includes the radiation slots 114, the first layer 206, the second layer 302, and the third layer 304, similar to those illustrated for the waveguide 202 in FIGS. 1-3. In other implementations, the waveguide 704 can include the first layer 508, the second layer 510, the third layer 512, the fourth layer 514, and the fifth layer 516, similar to those illustrated for the waveguide 504 in FIGS. 5A and 5B.

The waveguide 704 also includes the zigzag waveguide channel 606, similar to that illustrated for the waveguide 604 in FIGS. 6A and 6B. In other implementations, the waveguide 704 can include an approximately rectangular waveguide channel similar to the waveguide channel 112 illustrated of the waveguide 202 of FIG. 2.

The cavities 706 are formed as recesses or cavities in the first layer 206. In the depicted implementation, the cavity of the cavities 706 has an approximately rectangular shape. The cavities 706 can have an approximately circular shape, oval shape, C shape, T shape, or L shape in other implementations. In yet other implementations, the cavities 706 can combine the described shapes. Like the dipole element 116 of FIG. 2, a cavity 706 is positioned adjacent to and offset from a longitudinal side of each radiation slot 114.

As depicted in FIG. 7A, the cavities 706 include an array of cavities positioned on both longitudinal sides of the radiation slots 114. In other implementations, the cavities 706 can include a single cavity 706 positioned on both longitudinal sides of the radiation slots 114. In other words, the cavities 706 can include two approximately rectangular cavities that extend lengthwise in the longitudinal direction from the radiation slot 114 nearest to the opening of the zigzag waveguide channel 606 to the radiation slot 114 nearest the closed end of the zigzag waveguide channel 606. The cavities of the cavities 706 are sized and positioned to produce a radiation pattern with a narrow beamwidth.

### Example Method

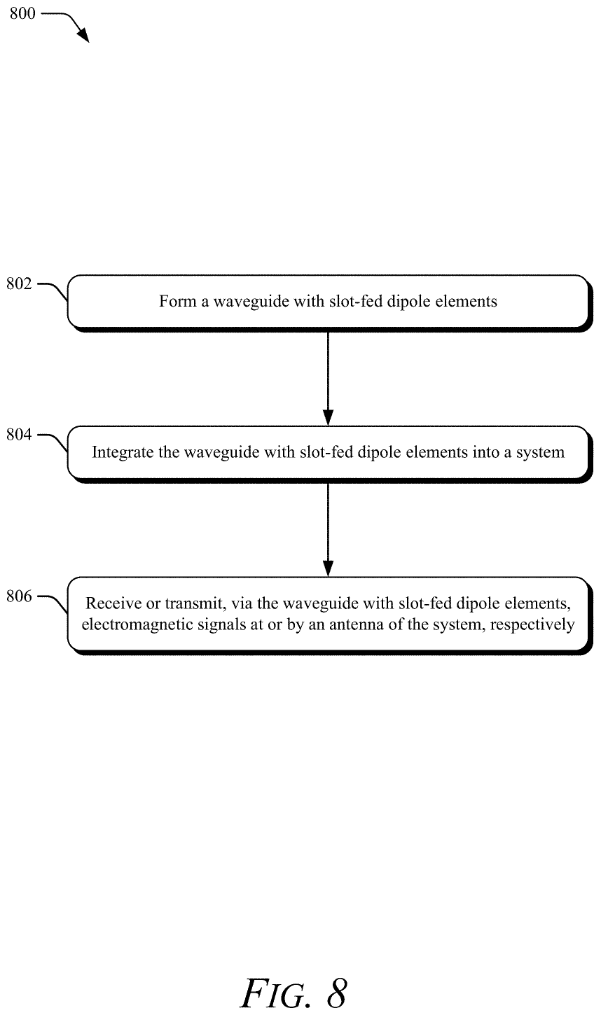

FIG. 8 illustrates an example method 800 that can be used for manufacturing a waveguide with slot-fed dipole elements, following techniques, apparatuses, and systems of this disclosure. Method 800 is shown as sets of operations (or acts) performed, but not necessarily limited to the order or combinations in which the operations are shown herein. Further, any of one or more of the operations may be repeated, combined, or reorganized to provide other methods. In portions of the following discussion, reference may be made to the environment 100 of FIG. 1 and entities detailed in FIGS. 1 through 7, reference to which is made for example only. The techniques are not limited to performance by one entity or multiple entities.

At 802, a waveguide with slot-fed dipole elements is formed. For example, the waveguide 110, 202, 504, 604, and/or 704 can be stamped, etched, cut, machined, cast, molded, or formed in some other way.

At 804, the waveguide is integrated into a system. For example, the waveguide 110, 202, 504, 604, and/or 704 is electrically coupled to the antenna 204.

At 806, electromagnetic signals are received or transmitted via the waveguide at or by an antenna of the system, respectively. For example, the antenna 204 receives or transmits signals captured via the waveguide 110, 202, 504, 604, and/or 704 and routed through the radar system 102.

### Examples

In the following section, examples are provided.

Example 1: An apparatus comprising: a waveguide including a hollow channel for a dielectric, the hollow channel forming: a first opening in a longitudinal direction at one end of the waveguide; a closed wall at an opposite end of the waveguide; a plurality of radiation slots, each of the radiation slots comprising a second opening through a surface of the waveguide that defines the hollow channel, each of the radiation slots being operably connected with the dielectric; and a plurality of dipole elements positioned on or in the surface, one of the plurality of dipole elements positioned adjacent to and offset from each longitudinal side of each radiation slot of the plurality of radiation slots, each longitudinal side being parallel with the longitudinal direction through the hollow channel, the plurality of dipole elements and the plurality of radiation slots being arranged on the surface to produce a particular radiation pattern for an antenna element that is electrically coupled to the dielectric from a floor of the hollow channel.

Example 2: The apparatus of example 1, wherein: the waveguide includes a printed circuit board (PCB) having a first conductive layer, a second substrate layer, and a third conductive layer, wherein: the plurality of radiation slots are formed in the third conductive layer of the PCB; and the plurality of dipole elements are formed in the first conductive layer of the PCB and operably connected, using via holes, to the third conductive layer.

Example 3: The apparatus of example 1, wherein each of the plurality of dipole elements is offset a first distance from each longitudinal side of each radiation slot, the first distance being selected to generate a particular band of coverage in the radiation pattern of the antenna element.

Example 4: The apparatus of example 1, wherein each of the plurality of dipole elements has a height less than a depth of each of the plurality of radiation slots.

Example 5: The apparatus of example 1, wherein the plurality of dipole elements have an approximately rectangular shape.

Example 6: The apparatus of example 1, wherein the plurality of dipole elements have an approximately circular shape, oval shape, C shape, T shape, or L shape.

Example 7: The apparatus of example 1, wherein the first opening comprises an approximately rectangular shape and the hollow channel forms an approximately rectangular shape along the longitudinal direction.

Example 8: The apparatus of example 7, wherein the plurality of radiation slots are offset a non-uniform distance from a centerline of the hollow channel, the center line being parallel with the longitudinal direction.

Example 9: The apparatus of example 1, wherein the first opening comprises an approximately rectangular shape and the hollow channel forms a zigzag shape along the longitudinal direction of the waveguide.

Example 10: The apparatus of example 9, wherein the zigzag shape comprises multiple turns along the longitudinal direction, each of the multiple turns having a turning angle between 0 and 90 degrees.

Example 11: The apparatus of example 9, wherein the plurality of radiation slots is positioned along a centerline of the hollow channel, the center line being parallel with the longitudinal direction of the waveguide.

Example 12: The apparatus of example 11, wherein the plurality of dipole elements comprise two approximately rectangular dipole elements that extend along the longitudinal direction of the waveguide, the approximately rectangular dipole elements positioned adjacent to and offset from each longitudinal side of the plurality of radiation slots.

Example 13: The apparatus of example 1, wherein the first opening comprises an approximately square shape, oval shape, or circular shape.

Example 14: The apparatus of example 1, wherein the plurality of radiation slots is evenly distributed between the first opening and the closed wall along the longitudinal direction of the waveguide.

Example 15: The apparatus of example 1, wherein the waveguide comprises metal.

Example 16: The apparatus of example 1, wherein the waveguide comprises plastic.

Example 17: The apparatus of example 1, wherein the dielectric comprises air and the waveguide is an air waveguide.

Example 18: A system comprising: an antenna element; a device configured to transmit or receive electromagnetic signals via the antenna; and a waveguide including a hollow channel for a dielectric, the hollow channel forming: a first opening in a longitudinal direction at one end of the waveguide; a closed wall at an opposite end of the waveguide; a plurality of radiation slots, each of the radiation slots comprising a second opening through a surface of the waveguide that defines the hollow channel, each of the radiation slots being operably connected with the dielectric; and a plurality of dipole elements positioned on or in the surface, one of the plurality of dipole elements positioned adjacent to and offset from each longitudinal side of each radiation slot of the plurality of radiation slots, each longitudinal side being parallel with the longitudinal direction through the hollow channel, the plurality of dipole elements and the plurality of radiation slots being arranged on the surface to produce a particular radiation pattern for the antenna element that is electrically coupled to the dielectric from a floor of the hollow channel.

Example 19: The system of example 18, wherein the device comprises a radar system.

Example 20: The system of example 19, wherein the system is a vehicle.

### CONCLUSION

While various embodiments of the disclosure are described in the foregoing description and shown in the drawings, it is to be understood that this disclosure is not limited thereto but may be variously embodied to practice within the scope of the following claims. From the foregoing description, it will be apparent that various changes may be made without departing from the scope of the disclosure as defined by the following claims.

What is claimed is:

1. An apparatus comprising:
a waveguide including a hollow channel for a dielectric, the hollow channel forming:
a first opening in a longitudinal direction at one end of the waveguide;
a closed wall at an opposite end of the waveguide;
a plurality of radiation slots, each of the radiation slots comprising a second opening through a surface of the waveguide that defines the hollow channel, each of the radiation slots being operably connected with the dielectric; and
a plurality of dipole elements positioned on or in the surface, one of the plurality of dipole elements positioned adjacent to and offset from each longitudinal side of each radiation slot of the plurality of radiation slots, each longitudinal side being parallel with the longitudinal direction through the hollow channel, the plurality of dipole elements and the plurality of radiation slots being arranged on the surface to produce a particular radiation pattern for an antenna element that is electrically coupled to the dielectric from a floor of the hollow channel.

2. The apparatus of claim 1, wherein:
the waveguide includes a printed circuit board (PCB) having a first conductive layer, a second substrate layer, and a third conductive layer, wherein:
the plurality of radiation slots are formed in the third conductive layer of the PCB; and
the plurality of dipole elements are formed in the first conductive layer of the PCB and operably connected, using via holes, to the third conductive layer.

3. The apparatus of claim 1, wherein each of the plurality of dipole elements is offset a first distance from each longitudinal side of each radiation slot, the first distance being selected to generate a particular band of coverage in the radiation pattern of the antenna element.

4. The apparatus of claim 1, wherein each of the plurality of dipole elements has a height less than a depth of each of the plurality of radiation slots.

5. The apparatus of claim 1, wherein the plurality of dipole elements have an approximately rectangular shape.

6. The apparatus of claim 1, wherein the plurality of dipole elements have an approximately circular shape, oval shape, C shape, T shape, or L shape.

7. The apparatus of claim 1, wherein the first opening comprises an approximately rectangular shape and the hollow channel forms an approximately rectangular shape along the longitudinal direction.

8. The apparatus of claim 7, wherein the plurality of radiation slots are offset a non-uniform distance from a centerline of the hollow channel, the center line being parallel with the longitudinal direction.

9. The apparatus of claim 1, wherein the first opening comprises an approximately rectangular shape and the hollow channel forms a zigzag shape along the longitudinal direction of the waveguide.

10. The apparatus of claim 9, wherein the zigzag shape comprises multiple turns along the longitudinal direction, each of the multiple turns having a turning angle between 0 and 90 degrees.

11. The apparatus of claim 9, wherein the plurality of radiation slots is positioned along a centerline of the hollow channel, the center line being parallel with the longitudinal direction of the waveguide.

12. The apparatus of claim 11, wherein the plurality of dipole elements comprise two approximately rectangular dipole elements that extend along the longitudinal direction of the waveguide, the approximately rectangular dipole elements positioned adjacent to and offset from each longitudinal side of the plurality of radiation slots.

13. The apparatus of claim 1, wherein the first opening comprises an approximately square shape, oval shape, or circular shape.

14. The apparatus of claim 1, wherein the plurality of radiation slots is evenly distributed between the first opening and the closed wall along the longitudinal direction of the waveguide.

15. The apparatus of claim 1, wherein the waveguide comprises metal.

16. The apparatus of claim 1, wherein the waveguide comprises plastic.

17. The apparatus of claim 1, wherein the dielectric comprises air and the waveguide is an air waveguide.

18. A system comprising:
an antenna element;
a device configured to transmit or receive electromagnetic signals via the antenna; and
a waveguide including a hollow channel for a dielectric, the hollow channel forming:
a first opening in a longitudinal direction at one end of the waveguide;
a closed wall at an opposite end of the waveguide;
a plurality of radiation slots, each of the radiation slots comprising a second opening through a surface of the waveguide that defines the hollow channel, each of the radiation slots being operably connected with the dielectric; and
a plurality of dipole elements positioned on or in the surface, one of the plurality of dipole elements positioned adjacent to and offset from each longitudinal side of each radiation slot of the plurality of radiation slots, each longitudinal side being parallel with the longitudinal direction through the hollow channel, the plurality of dipole elements and the plurality of radiation slots being arranged on the surface to produce a particular radiation pattern for the antenna element that is electrically coupled to the dielectric from a floor of the hollow channel.

19. The system of claim 18, wherein the device comprises a radar system.

20. The system of claim 19, wherein the system is a vehicle.
